(19) United States
(12) Patent Application Publication
(10) Pub. No.: US 2009/0253484 A1
(43) Pub. Date: Oct. 8, 2009

(54) SLOT MACHINE WITH REPLICATING SYMBOL FEATURE AND CONTROL METHOD THEREOF

(75) Inventor: Hiroki Saito, Koto-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 12/136,344

(22) Filed: Jun. 10, 2008

Related U.S. Application Data
(60) Provisional application No. 61/042,388, filed on Apr. 4, 2008.

(51) Int. Cl. A63F 13/00

(52) U.S. Cl. 463/20

(57) ABSTRACT

In a slot machine, symbols are scrolled in plural display areas provided on a display at an execution of a slot game and then stopped in the display areas respectively. Furthermore, if a directing symbol containing a base symbol and an arrow has come to a stop in the display areas, the same base symbols as the base symbol contained in the directing symbol are displayed in the display areas positioned in the direction pointed by the arrow of the directing symbol. Therefore, since expectations for more awards are raised by a directing symbol (s) appearing, the slot machine with a superior entertainment feature can be provided.

### CROSS-REFERENCE TO RELATED APPLICATION

This application is based upon and claims the benefit of U.S. Provisional Patent Application Ser. No. 61/042,388, filed on Apr. 4, 2008; the entire contents of which are incorporated herein by reference for all purposes.

### BACKGROUND OF THE INVENTION

1. Field of the Invention

The present invention relates to a slot machine for playing games using medals and so on, and a control method of a slot machine.

2. Description of Related Art

Each slot machine disclosed in U.S. Pat. No. 5,820,459, U.S. Pat. No. 6,695,697, United States Patent Application Laid-Open No. 2003/0069073, European Patent Application Laid-Open No. 1192975, U.S. Pat. No. 6,254,483, U.S. Pat. No. 5,611,730, U.S. Pat. No. 5,639,088, U.S. Pat. No. 6,257,981, U.S. Pat. No. 6,234,896, U.S. Pat. No. 6,001,016, U.S. Pat. No. 6,273,820, U.S. Pat. No. 6,224,482, U.S. Pat. No. 4,669,731, U.S. Pat. No. 6,244,957, U.S. Pat. No. 5,910,048, U.S. Pat. No. 5,695,402, U.S. Pat. No. 6,003,013, U.S. Pat. No. 4,283,709, European Patent Application Laid-Open No. 0631798, German Patent Application Laid-Open No. 4137010, United Kingdom Patent Application Laid-Open No. 2326830, German Patent Application Laid-Open No. 3712841, U.S. Pat. No. 4,964,638, U.S. Pat. No. 6,089,980, U.S. Pat. No. 5,280,909, U.S. Pat. No. 5,702,303, U.S. Pat. No. 6,270,409, U.S. Pat. No. 5,770,533, U.S. Pat. No. 5,836,817, U.S. Pat. No. 6,932,704, U.S. Pat. No. 6,932,707, U.S. Pat. No. 4,837,728, European Patent Application Laid-Open No. 1302914, U.S. Pat. No. 4,624,459, U.S. Pat. No. 5,564,700, International Patent Application Laid-Open No. 03/083795, German Patent Application Laid-Open No. 3242890, European Patent Application Laid-Open No. 0840264, German Patent Application Laid-Open No. 10049444, International Patent Application Laid-Open No. 04/095383, European Patent Application Laid-Open No. 1544811, U.S. Pat. No. 5,890,963, European Patent Application Laid-Open No. 1477947 and European Patent Application Laid-Open No. 1351180, is known as a relevant slot machine.

In the slot machine, symbols come to stops in display areas and an award becomes higher as the number of appearing scatter symbols increases. Then, a slot machine having a new entertainment feature with an appearing probability of more scatter symbols is desired to be produced.

### SUMMARY OF THE INVENTION

A first aspect of the present invention provides a slot machine that includes a display including plural display areas, in each of which a base symbol or a directing symbol containing a base symbol and a directing sign is arranged, and a controller. The controller is operable to (A) rearrange one of the base symbol and the directing symbol in each of the display areas after receiving an input from an external, (B) set, when the directing symbol has been rearranged in the display areas, the base symbol in each of the display areas positioned in a direction pointed by the directing sign contained in the rearranged directing symbol to the same base symbol as the base symbol contained in the rearranged directing symbol, and (C) provide an award according to a symbol combination with the base symbols displayed in the display areas.

A second aspect of the present invention provides a slot machine that includes a display including plural display areas, in each of which a base symbol or a directing symbol containing a base symbol and a directing sign is arranged, and a controller. The controller is operable to (A) rearrange the base symbol or the directing symbol in each of the display areas after receiving an input from an external, (B) change, after the base symbol or the directing symbol has been rearranged in each of the display areas, the base symbol in each of the display areas positioned in a direction pointed by the directing sign contained in the rearranged directing symbol to the same base symbol as the base symbol contained in the rearranged directing symbol, and (C) provide an award according to a symbol combination with the base symbols displayed in the display areas.

A third aspect of the present invention provides a slot machine that includes a display including plural display areas, in each of which a base symbol or a directing symbol containing a base symbol and a directing sign is arranged, and a controller. The controller is operable to (A) rearrange the base symbol or the directing symbol in each of the display areas after receiving an input from an external, (B) change, after the base symbol or the directing symbol has been rearranged in each of the display areas, the base symbol in each of the display areas positioned in a direction pointed by the directing sign contained in the rearranged directing symbol to a combined symbol containing the base symbol had been arranged therein and the same base symbol as the base symbol contained in the rearranged directing symbol, and (C) provide an award according to a symbol combination with the base symbols and the combined symbols displayed in the display areas.

A fourth aspect of the present invention provides a slot machine that includes a display including plural display areas, in each of which a base symbol or a directing symbol containing a base symbol, a directing sign and a numeric value is arranged, and a controller. The controller is operable to (A) rearrange the base symbol or the directing symbol in each of the display areas after receiving an input from an external, (B) set, when the directing symbol has been rearranged in the display areas, the number, which is indicated the numeric value contained in the rearranged directing symbols, of the base symbols in the display areas positioned in a direction pointed by the directing sign contained in the rearranged directing symbol to the same base symbol as the base symbol contained in the rearranged directing symbol, and (C) provide an award according to a symbol combination with the base symbols displayed in the display areas.

A fifth aspect of the present invention provides a control method of a slot machine that includes, rearranging symbol being arranged in each of plural display areas on a display to a base symbol or a directing symbol containing a base symbol and a directing sign, changing, when the directing symbol has been rearranged in the display areas, the base symbol in each of the display areas positioned in a direction pointed by the directing sign contained in the rearranged directing symbol to the same base symbol as the base symbol contained in the rearranged directing symbol, and providing an award according to a symbol combination with the base symbols displayed in the display areas.

### BRIEF DESCRIPTION OF THE DRAWINGS

FIG. 1 is a screen example showing symbols displayed on a display of a slot machine in a first embodiment according to the present invention;

FIG. 2 is another screen example showing symbols displayed on the display of the slot machine in the first embodiment according to the present invention;

FIG. 3 is an overall view showing a configuration of the slot machine in the first embodiment according to the present invention;

FIG. 4 is a block diagram showing an internal configuration of the slot machine in the first embodiment according to the present invention;

FIG. 5 is a diagram showing display areas provided on the display of the slot machine in the first embodiment according to the present invention;

FIG. 6 is an example of an awards setting table used in the first embodiment of the slot machine according to the present invention;

FIG. 7 is a flow-chart of slot game execution processing in the first embodiment of the slot machine according to the present invention;

FIG. 8 is a flow-chart of image effect control processing in the first embodiment of the slot machine according to the present invention;

FIG. 9 is a flow-chart of payout processing in the first embodiment of the slot machine according to the present invention;

FIG. 10 is yet another screen example showing symbols displayed on the display of the slot machine in the first embodiment according to the present invention;

FIG. 11 is a flow-chart of image effect control processing in a second embodiment of the slot machine according to the present invention;

FIG. 12 is a screen example showing symbols displayed on the display of the slot machine in the second embodiment according to the present invention;

FIG. 13 is another screen example showing symbols displayed on the display of the slot machine in the second embodiment according to the present invention;

FIG. 14 is yet another screen example showing symbols displayed on the display of the slot machine in the second embodiment according to the present invention;

FIG. 15 is a flow-chart of image effect control processing in a third embodiment of the slot machine according to the present invention;

FIG. 16 is a screen example showing symbols displayed on the display of the slot machine in the third embodiment according to the present invention;

FIG. 17 is another screen example showing symbols displayed on the display of the slot machine in the third embodiment according to the present invention; and

FIG. 18 is yet another screen example showing symbols displayed on the display of the slot machine in the third embodiment according to the present invention.

### DETAILED DESCRIPTION OF THE EMBODIMENTS

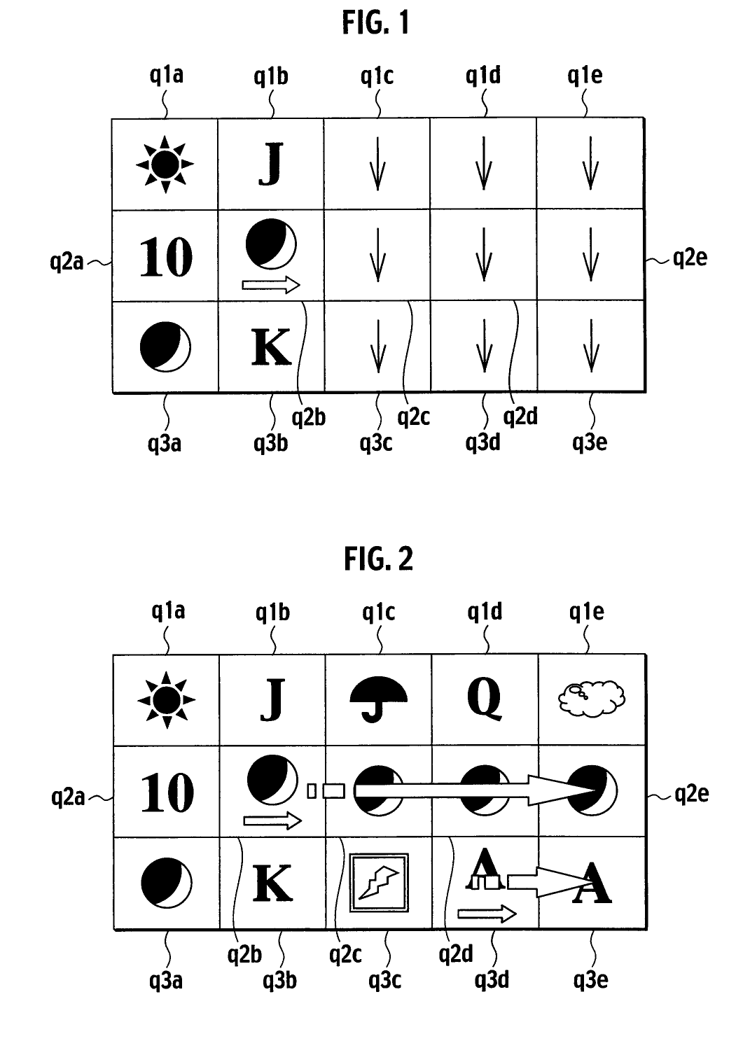

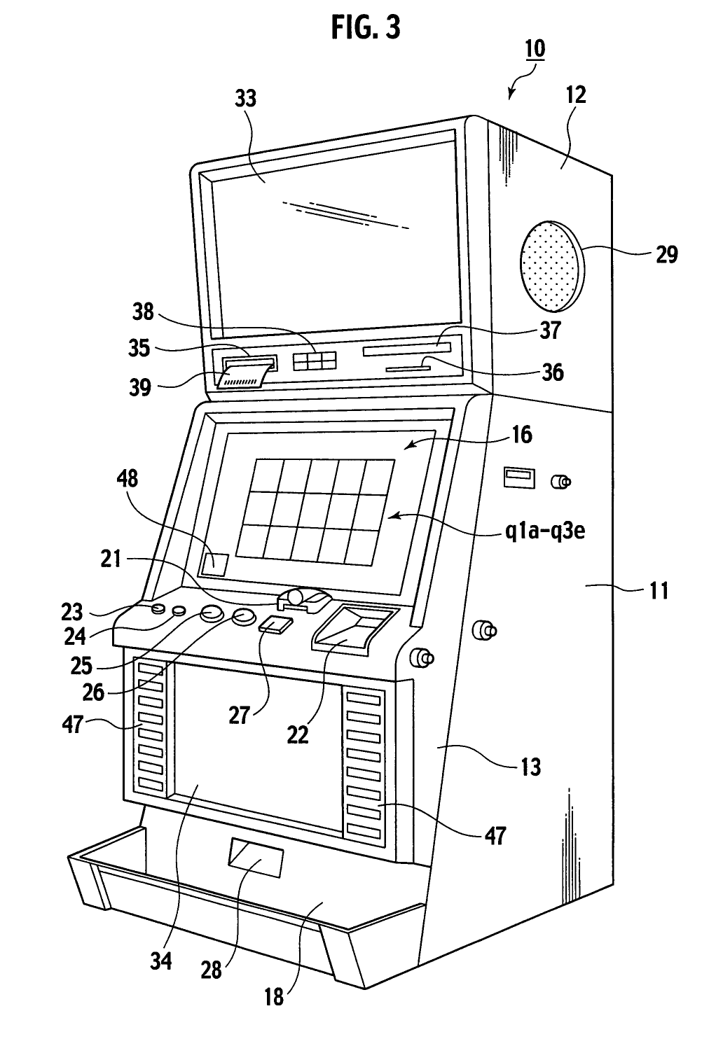

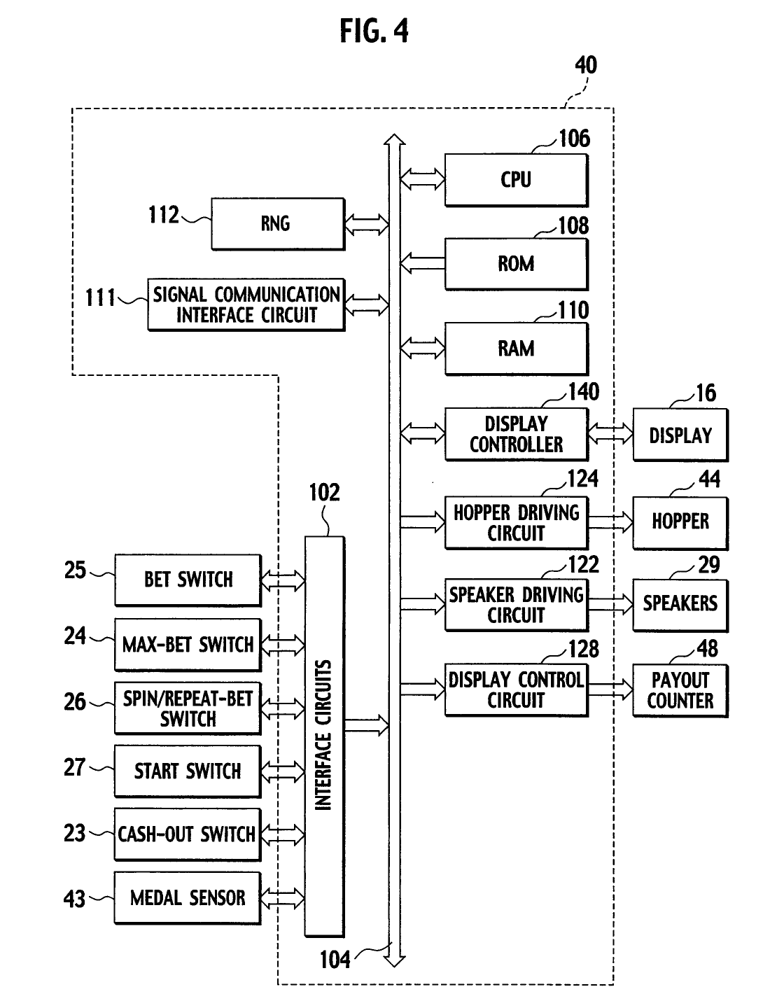

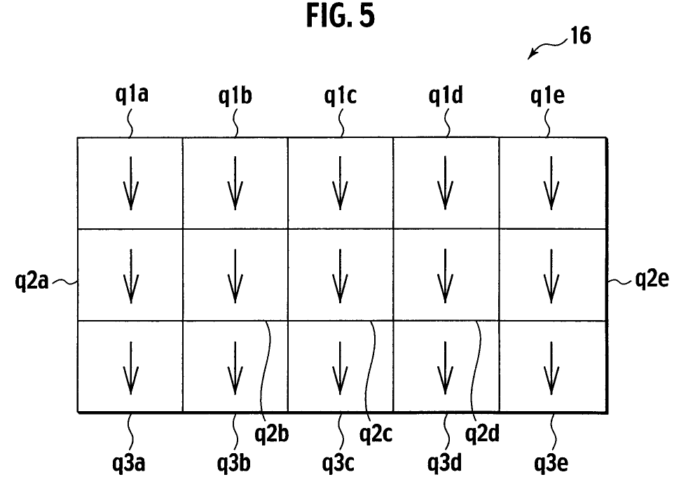

FIG. 1 and FIG. 2 are explanatory diagrams showing screen examples with base symbols displayed on a display 16 (see FIG. 3 and FIG. 4) of a slot machine according to the present invention. FIG. 1 shows a state where base symbols are displayed in display areas of the first and second columns from the left. FIG. 2 shows a state where base symbols are displayed in all display areas q1a to q3e. An outline of the slot machine according to the present invention will be explained hereinbelow with reference to FIG. 1 and FIG. 2.

In the slot machine according to the present invention, after starting a slot game, base symbols and a directing symbol(s) that is combined with a base symbol and an arrow are scrolled in fifteen display areas q1a to q3e provided on the display 16 (hereinbelow, “base symbol” and “directing symbol” are called as “symbol” collectively) and then stopped sequentially in the display areas q1a to q3e. If the stopped symbols includes the directing symbol (s) as shown in the display area q2b in FIG. 2, the base symbols displayed in the display areas q2c, q2d and q2e positioned in the direction pointed by the arrow of the directing symbol (on the right side in this case) are set to the same base symbols as the base symbol contained in the directing symbol.

Specifically, when a directing symbol composed of a “MOON” symbol (base symbol) and an arrow (directing sign) has come to a stop in the display area q2b as shown in FIG. 1, “MOON” symbols come to stops in the display areas q2c, q2d and q2e on the right side of the display area q2b as shown in FIG. 2. Similarly, when a directing symbol composed of an “A” symbol and an arrow has come to a stop in the display area q3d as shown in FIG. 2, an “A” symbol comes to a stop in the display area q3e positioned on the right side of the display area q3d.

Therefore, since expectations for appearing more of the same base symbols are raised when a directing symbol(s) has appeared in the display areas q1a to q3e, a slot machine with a superior entertainment feature can be provided.

Next, a configuration of a slot machine 10 in the present embodiment will be explained in detail. FIG. 3 is a perspective view showing a configuration of the slot machine 10 according to the present invention. As shown in FIG. 3, the slot machine 10 in the present embodiment includes a cabinet 11, a top box 12 provided on top of the cabinet 11 and a main door 13. The cabinet 11 has a display 16 disposed on its plane facing a player. In addition, various component devices are disposed within the cabinet 11, such as the controller 40 (see FIG. 4) for electrically controlling the slot machine 10 and a hopper 44 (see FIG. 4) for controlling an insertion, pooling, and a cash-out of medals.

Here in the present embodiment, medals are used for gaming media used at game executions. However, gaming media are not limited to medals only. For example, coins, tokens, electronic money or other equivalent electronic value information (credits) may be also used as gaming media.

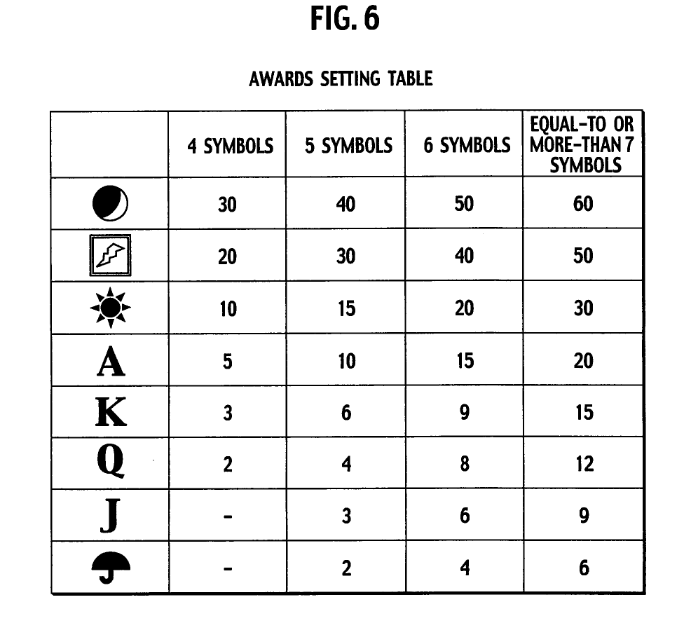

The main door 13 is attached to the cabinet 11 so that it can be opened and closed. The display 16 is disposed on an upper portion of the main door 13. As explained later, images relating to various games including a slot game are displayed on the display 16. As shown in FIG. 5, in a slot game, scrolled and then stopped are base symbols which had been displayed in the fifteen display areas q1a to q3e disposed in a three-rows by five-columns matrix manner (symbols had been arranged are rearranged). And then, a predetermined amount of a payout will be awarded in appearing a prescribed number of identical base symbols in the fifteen display areas q1a to q3e as defined in an awards setting table shown in FIG. 6.

Here, as shown in FIG. 5, suffixes “a” to “e” attached to the display areas “q” are represent columns and suffixes “1” to “3” are represent rows. Therefore, the central display area is indicated as “q2c”. Note that, in the present embodiment, a slot game is executed with the three-rows by five-columns display areas. However, the present invention is not limited to this.

In addition, a payout counter 48 for displaying a payout amount is disposed at the lower-left area on the display 16 shown in FIG. 3.

A medal insertion slot 21, into which medals are inserted at game plays, and a bill validator 22, which validates bills and accepts valid ones, are disposed beneath the display 16. Various operational switches are disposed nearby the medal insertion slot 21 and the bill validator 22.

A cash-out switch 23, a max-bet switch 24, a bet switch 25, a spin/repeat-bet switch 26 and the start switch 27 are provided as the operational switches.

The bet switch 25 is a switch for determining a bet amount on each slot game executed by on the display 16. Each time the bet switch 25 is pressed, one credit corresponding to one medal is bet.

The spin/repeat-bet switch 26 is a switch for placing a bet again on a current slot game without changing a bet amount had been placed by the bet switch 25 on the last slot game.

The start switch 27 is a switch for starting a slot game after a bet with desired credits has been placed by the bet switch 25. A slot game is started with the display areas q1a to q3e on the display 16 after a bet has been placed by a medal(s) insertion into the medal insertion slot 21 or by the bet switch 25 and then the start switch 27 has been pressed.

The cash-out switch 23 is a switch for cashing out medals being inserted. The medals to be cashed out are discharged from a medal cash-out chute 28 opened in the front lower part of the main door 13 and then pooled on a medal tray 18.

The max-bet switch 24 is a switch for betting maximum credits amount (e.g. equivalent to thirty medals) that can be bet on a single game by one pressing.

A foot display 34 is disposed on the lower front of the main door 13 to display various images relating to games of the slot machine 10. These images are, for example, characters of the slot machine 10 and so on.

Lamps 47 are disposed on both side of the foot display 34 to be illuminated based on preset illuminating patterns for the slot machine 10. The medal cash-out chute 28 is disposed beneath the foot display 34.

An upper display 33 is disposed on the front of the top box 12. The upper display 33 has a display panel to display relationships between the number of displayed base symbols and awards, etc.

In addition, speakers 29 are provided on the top box 12. A ticket printer 35, a card reader 36, a data display 37 and a keypad 38 are disposed beneath the upper display 33. The ticket printer 35 prints a bar-code, which contains data, such as a credit amount, time and date and an identification number of the slot machine 10, on a ticket and outputs it as a bar-code ticket 39.

A player can play games at another slot machine with the bar-code ticket 39 being read by the other slot machine, and can exchange the bar-code ticket 39 for bills and so on at a predetermined site in an amusement facility (e.g. a cashier in a casino).

A smart card can be inserted into the card reader 36, and the card reader 36 reads data from the inserted smart card and writes data onto the smart card. A smart card is carried by a player and stores the player's identification data, gaming history data of games played by the player and so on.

FIG. 4 is a block diagram showing an electrical configuration of the controller 40 and various components connected to the controller 40, which are provided within the slot machine 10 of the present embodiment. The controller 40 of the slot machine 10 shown in FIG. 4 is a microcomputer and includes interface circuits 102, an input/output (I/O) bus 104, a CPU 106, a ROM 108, a RAM 110, a signal communication interface (I/F) circuit 111, a random number generator (RNG) 112, a speaker drive circuit 122, a hopper drive circuit 124, a display control circuit 128 and a display controller 140.

The interface circuits 102 are connected to the I/O bus 104 and the I/O bus 104 transmits data signals and address signals with the CPU 106.

The start switch 27 is connected to the interface circuits 102. A start command output from the start switch 27 is transmitted to the CPU 106 via the I/O bus 104 after converted into a predetermined signal by the interface circuits 102.

Furthermore, the bet switch 25, the max-bet switch 24, the spin/repeat-bet switch 26 and the cash-out switch 23 are connected to the interface circuits 102. A switching signal output from each of the switches 25, 14, 26 and 23 is transmitted to the CPU 106 via the I/O bus 104 after converted into a predetermined signal by the interface circuits 102.

In addition, a medal sensor 43 is connected to the interface circuits 102. The medal sensor 43 is a sensor for detecting a medal(s) has been inserted into the medal insertion slot 21 and disposed inside the medal insertion slot 21. A detection signal output from the medal sensor 43 is transmitted to the CPU 106 via the I/O bus 104 after converted into a predetermined signal by the interface circuits 102.

In addition, the ROM 108 for storing system programs and the RAM 110 for storing various data are connected to the I/O bus 104. Furthermore, the RNG 112, the signal communication I/F circuit 111, the display controller 140, the hopper drive circuit 124, the speaker drive circuit 122 and the display control circuit 128 are connected to the I/O bus 104.

The CPU 106 is triggered by the start switch 27 receiving a game start operation and then reads out the game execution programs to execute a slot game. The game execution programs are programs for executing a slot game on the display 16 via the display controller 140.

Specifically, the game execution programs are programmed to execute a slot game, in which symbols are scrolled and then stopped in the fifteen display areas q1a to q3e (see FIG. 5) and an award is provided based on symbols displayed in the fifteen display areas q1a to q3e.

The signal communication I/F circuit 111 is connected to a hall server etc. and transmits gaming history data of the slot machine 10 etc. to the hall server. In addition, the signal communication I/F circuit 111 receives various data transmitted from the hall server.

The RNG 112 generates random numbers for determining whether or not to achieve a winning combination in a slot game executed on the display 16.

The display control circuit 128 controls displaying a payout amount on the payout counter 48 provided at the lower-left area on the display 16.

The speaker drive circuit 122 outputs sound data to the speakers 29. Specifically, the CPU 106 reads the sound data stored in the ROM 108 and transmits the sound data to the speaker drive circuit 122 via the I/O bus 104. As a result, predetermined effect sounds are output from the speakers 29.

The hopper drive circuit 124 outputs a cash-out command to the hopper 44 when providing a cash-out. Specifically, the CPU 106 outputs a drive command to the hopper drive circuit 124 via the I/O bus 104 when receiving the cash-out command from the cash-out switch 23. As a result, the hopper 44 cashes out medals equivalent to current credits stored in a prescribed memory area within the RAM 110.

The display controller 140 controls displaying executions of slot games on the display 16. Specifically, the CPU 106 generates an image display command according to a status and a game result of a slot game and then outputs the image display command to the display controller 140 via the I/O bus 104. On receiving the image display command, the display controller 140 generates a drive command for the display 16 based on the image display command and then outputs the drive command to the display 16. As a result, prescribed images are displayed on the display 16.

Next, relationships between base symbols displayed in the display areas q1a to q3e on the display 16 and awards to be provided to a player will be explained with reference to FIG. 6.

Any one of nine base symbols “MOON”, “LIGHTING”, “SUN”, “A”, “K”, “Q”, “J”, “UMBRELLA” and “CLOUD” will be displayed in each of the fifteen display areas on the display 16. In addition, as explained later, a directing symbol(s) that contains a base symbol (above-mentioned nine kinds of symbols) and an arrow (directing sign) may appear. When a directing symbol(s) has appeared, symbols displayed in the display areas positioned in the direction pointed by the arrow are set to the same symbol as the base symbol contained in the directing symbol.

The relationships between base symbols displayed in the fifteen display areas q1a to q3e and awards are defined as shown in FIG. 6.

For example, an award with twenty medals is provided when four “LIGHTING” symbols have appeared. An award with thirty medals is provided when the five symbols have appeared. An award with forty medals is provided when the six symbols have appeared. An award with fifty medals is provided when the equal-to or more-than seven symbols have appeared.

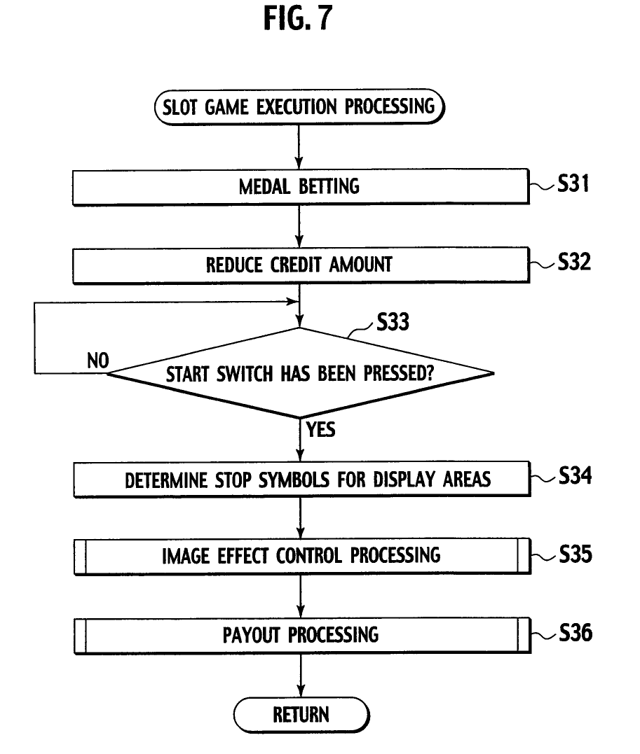

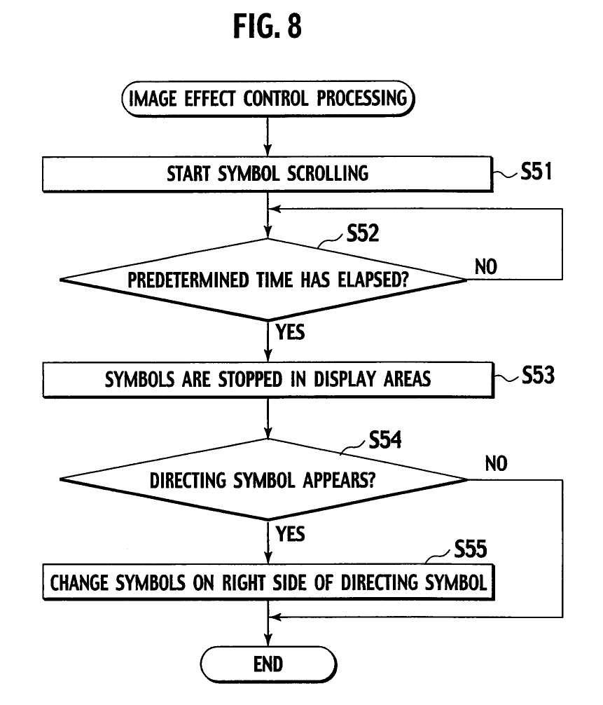

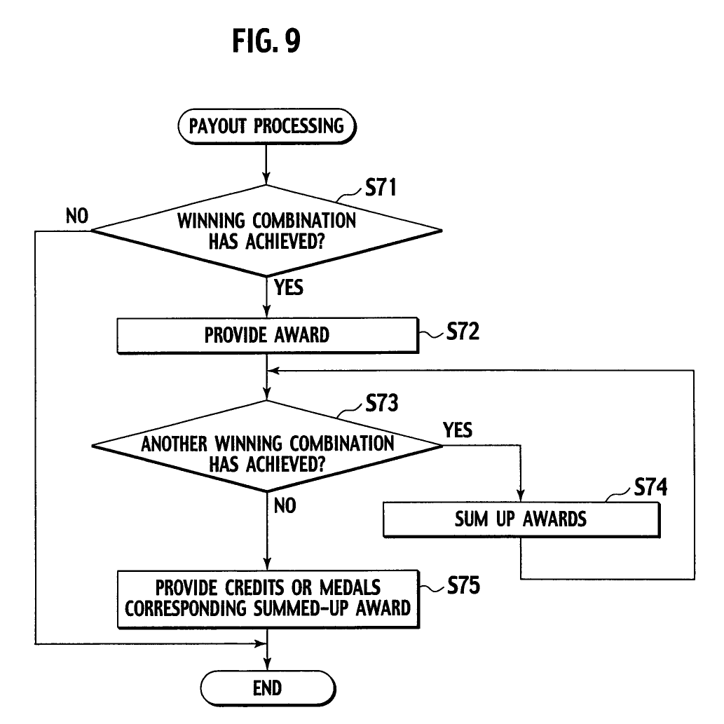

Next, operations of the slot machine 10 in the first embodiment will be explained with reference to flow-charts shown in FIG. 7, FIG. 8 and FIG. 9. FIG. 7 is a flow-chart showing procedures in slot game execution processing executed by the slot machine 10 in the first embodiment.

First, the CPU 106 (see FIG. 4) accepts a player's bet with medals or credits (step S31). Specifically, when the player placed a bet with a desired credit amount by pressing the bet switch 25 or inserted medals corresponding to a desired medal amount into the medal insertion slot 25, the amount is input as a bet amount.

The CPU 106 reduces current credits by the credits amount when the bet has been placed by pressing the bet switch 25 (step S32). For example, if a ten-credit bet has been placed under thirty credits, the credits become twenty by reducing.

The CPU 106 judges whether or not the start switch 27 has been pressed (step S33). If the start switch 27 has been pressed (YES in step S33), stop symbol determination processing is executed for the fifteen display areas q1a to q3e (step S34). In this processing, determined are base symbols and a directing symbol(s) to be displayed in the fifteen display areas q1a to q3e, based on random numbers generated by the RNG 112.

The CPU 106 executes image effect control processing (step S35). In this processing, the stop symbols determined in step S34 are displayed in the display areas q1a to q3e. The image effect control processing will be explained later in detail.

Subsequently, the CPU 106 executes payout processing based on the base symbols had been displayed in the fifteen display areas q1a to q3e (step S36). The payout processing will be explained later in detail.

Next, the image effect control processing of step S35 in FIG. 7 will be explained with reference to FIG. 8.

First, the CPU 106 transmits a command signal to start symbol scrolling to the display controller 140. The display controller 140 starts symbol scrolling (base symbol/directing symbol) in the fifteen display areas q1a to q3e on the display 16 on receiving the command signal (step S51).

The CPU 106 counts an elapsed time since the symbol scrolling has been started and judges whether or not a predetermined time (e.g. five seconds) has elapsed (step S52). If the predetermined time has elapsed (YES in step S52), the CPU 106 stops symbols (base symbol/directing symbol) sequentially from the left side in the fifteen display areas q1a to q3e (step S53). Note that, a directing symbol is a symbol containing a base symbol and an arrow.

As a result, when a directing symbol containing a “MOON” symbol and an arrow has appeared in the display area q2b as shown in FIG. 1 (YES in step S54), “MOON” symbols are displayed in all of the display areas q2c, q2d and q2e on the right side of the display area q2b as shown in FIG. 2 (step S55). Similarly, when a directing symbol containing an “A” symbol and an arrow has appeared in the display area q3d as shown in FIG. 2, another “A” symbol is displayed in the display area q3e on the right side of the “A” symbol. Subsequently, the arrows are erased and then only base symbols are displayed in the fifteen display areas q1a to q3e. And then, this processing is terminated.

Next, the payout processing of step S36 in FIG. 7 will be explained with reference to FIG. 9.

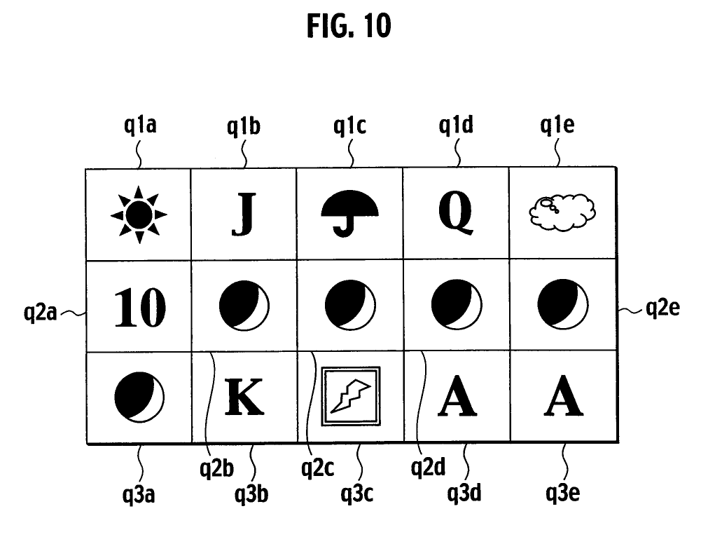

First, the CPU 106 judged whether or not a winning combination has been achieved according to base symbols displayed in the fifteen display areas q1a to q3e (step S71). In the example shown in FIG. 10, since five “MOON” symbols are displayed, a forty medal award is provided as defined in the awards setting table shown in FIG. 6 (step S72).

Subsequently, the CPU 106 judges whether or not another winning symbol combination has been achieved (step S73). If the other winning symbol combination other than that by the “MOON” symbols has been achieved (YES in step S73), an award according to the other winning symbol combination is added up (step S74). On the other hand, if no winning base symbol combination has been achieved (NO in step S73), the CPU 106 provides credits or medals corresponding to the summed-up award (step S75). As a result, the forty medal award is provided in the example shown in FIG. 10 and then a payout with credits or medals is provided.

As explained above, in the slot machine 10 according to the first embodiment of the present invention, symbols are scrolled and then stopped in the fifteen display areas q1a to q3e. If a directing symbol(s) has appeared among the stopped symbols, symbols on the right side (positioned in the direction pointed by the arrow) of the directing symbol(s) are set to the same symbol as the base symbol contained in the directing symbol. Therefore, since expectations for more awards are provided to a player, an entertainment feature is advanced.

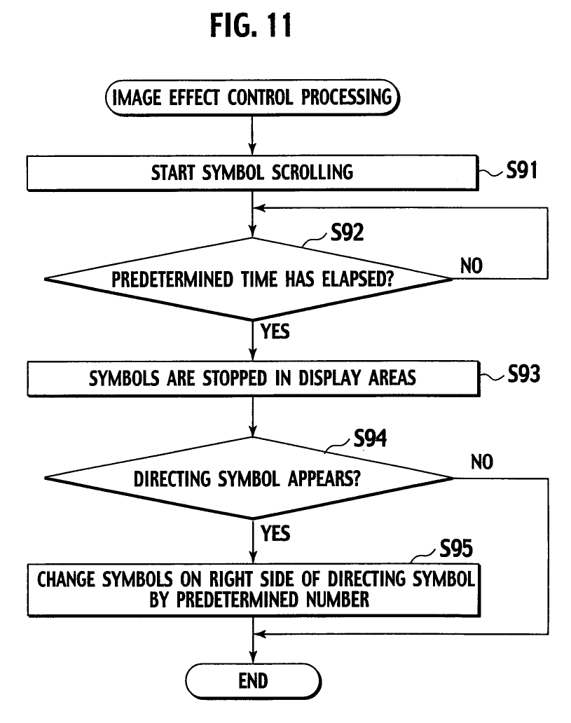

Next, a slot machine in a second embodiment according to the present invention will be explained. In the slot machine 10 of the second embodiment, its overall configuration and its electrical configuration are the same as shown in FIG. 3 and FIG. 4. In the second embodiment, image control processing is different from that in the first embodiment shown in step S35 in FIG. 7. The image control processing in the second embodiment will be explained hereinbelow with reference to a flow-chart shown in FIG. 11.

First, the CPU 106 transmits a command signal to start symbol scrolling to the display controller 140. The display controller 140 starts symbol scrolling in the fifteen display areas q1a to q3e on the display 16 on receiving the command signal (step S91).

The CPU 106 counts an elapsed time since the symbol scrolling has been started and judges whether or not a predetermined time (e.g. five seconds) has elapsed (step S92). If the predetermined time has elapsed (YES in step S92), the CPU 106 stops symbols (base symbol/directing symbol) sequentially from the left side in the fifteen display areas q1a to q3e (step S93). Note that, a directing symbol is a symbol containing a base symbol, an arrow and a numeric value.

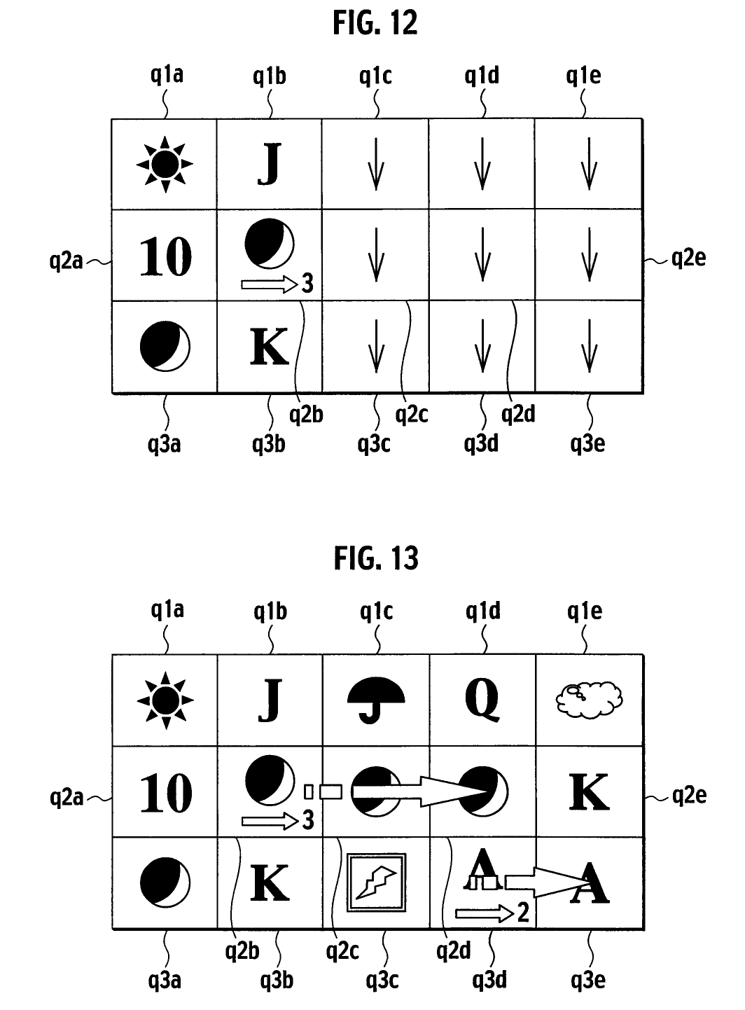

As a result, when a directing symbol containing a “MOON” symbol, an arrow and a numeric value “3” has appeared in the display area q2b as shown in FIG. 12 (YES in step S94), “MOON” symbols are displayed in the two display areas q2c and q2d on the right side of the display area q2b as shown in FIG. 13 (step S95). In other words, total three “MOON” symbols are displayed. Similarly, when a directing symbol containing an “A” symbol, an arrow and a numeric value “2” has appeared in the display area q3d as shown in FIG. 13, an “A” symbol is displayed in the one display area q3e on the right side of the directing symbol. In other words, total two “A” symbols are displayed. Subsequently, the arrows and the numeric values are erased and then only base symbols are displayed in the fifteen display areas q1a to q3e. And then, this processing is terminated.

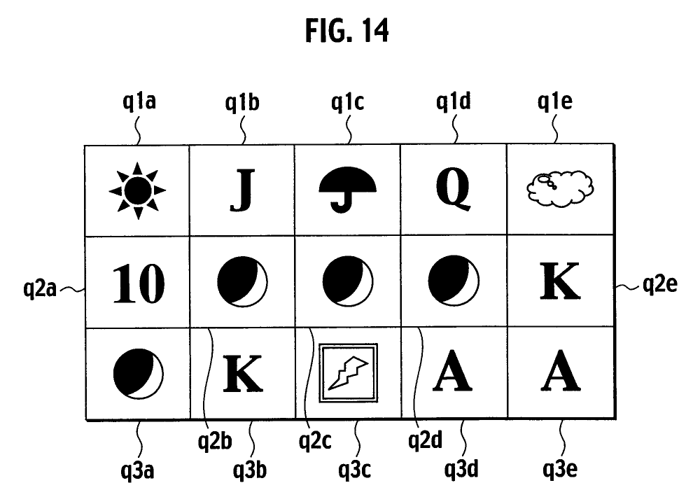

Subsequently, a payout is awarded according to the base symbols displayed in the display areas according to the same processes as shown in FIG. 9. In the example shown in FIG. 14, since four “MOON” symbols are displayed, a thirty medal award is provided as defined in the awards setting table shown in FIG. 6.

As explained above, in the slot machine 10 according to the second embodiment of the present invention, symbols are scrolled and then stopped in the fifteen display areas q1a to q3e. If a directing symbol(s) has appeared among the stopped symbols, a predetermined number (indicated by a numeric value) of symbols on the right side (positioned in the direction pointed by the arrow) of the directing symbol(s) are set to the same symbol as the base symbol contained in the directing symbol. Therefore, since expectations for more awards are provided to a player, an entertainment feature is advanced.

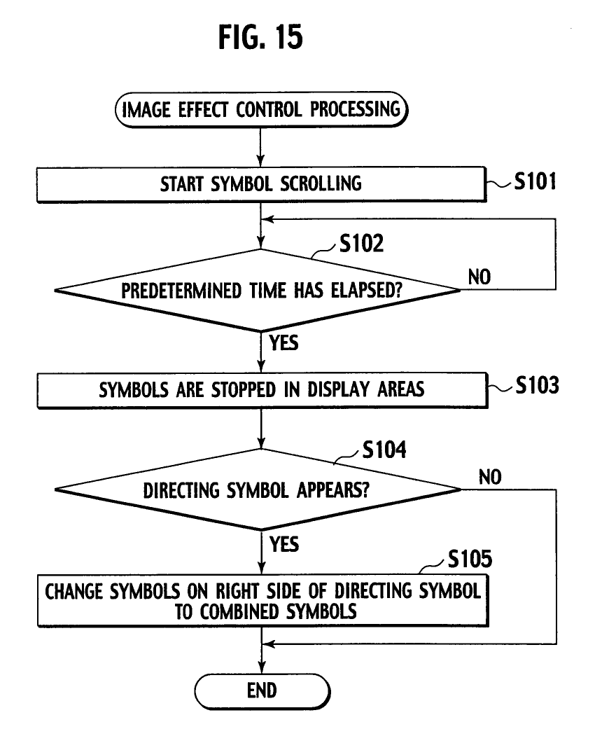

Next, a slot machine in a third embodiment according to the present invention will be explained. In the slot machine 10 of the third embodiment, its overall configuration and its electrical configuration are the same as shown in FIG. 3 and FIG. 4. In the second embodiment, image control processing is different from that in the first embodiment shown in step S35 in FIG. 7. The image control processing in the third embodiment will be explained hereinbelow with reference to a flow-chart shown in FIG. 15.

First, the CPU 106 transmits a command signal to start symbol scrolling to the display controller 140. The display controller 140 starts symbol scrolling in the fifteen display areas q1a to q3e on the display 16 on receiving the command signal (step S101).

The CPU 106 counts an elapsed time since the symbol scrolling has been started and judges whether or not a predetermined time (e.g. five seconds) has elapsed (step S102). If the predetermined time has elapsed (YES in step S102), the CPU 106 stops symbols (base symbol/directing symbol) sequentially from the left side in the fifteen display areas q1a to q3e (step S103). Note that, a directing symbol is a symbol containing a base symbol and an arrow.

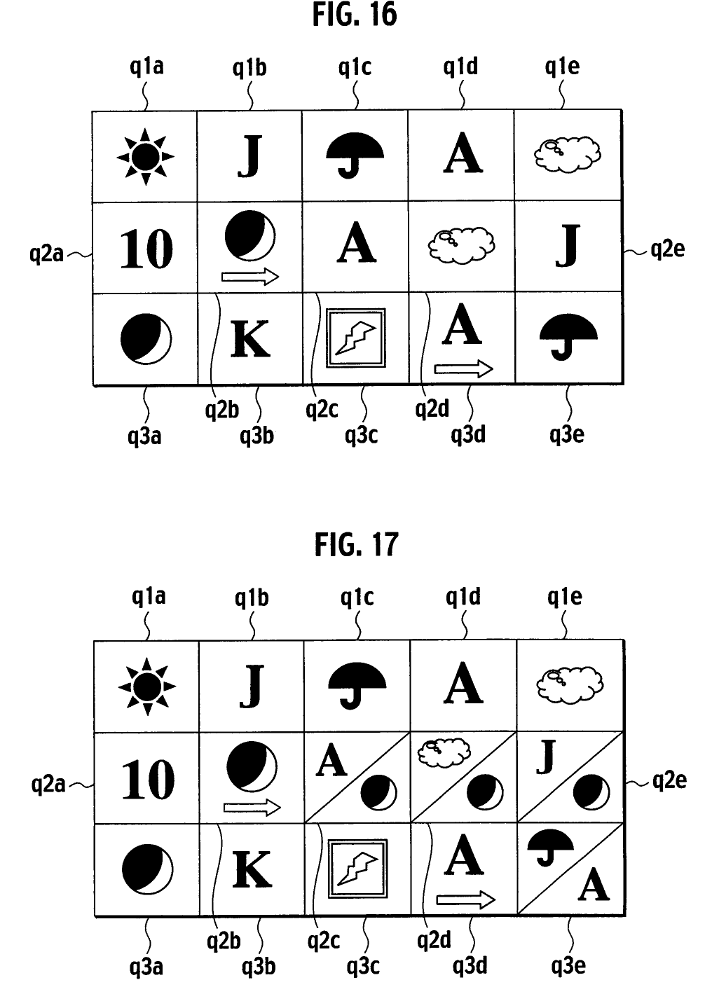

As a result, when a directing symbol containing a “MOON” symbol and an arrow has appeared in the display area q2b and also a directing symbol containing an “A” symbol and an arrow has appeared in the display area q3d as shown in FIG. 16 (YES in step S104), combined symbols each of which is composed of the base symbol had been displayed and a “MOON” symbol are displayed in the display areas q2c, q2d and q2e on the right side of the directing symbol in the display area q2b as shown in FIG. 17 (step S105). Specifically, a combined symbol composed of a “Q” symbol and a “MOON” symbol is displayed in the display area q2c. A combined symbol composed of a “CLOUD” symbol and a “MOON” symbol is displayed in the display area q2d. A combined symbol composed of a “J” symbol and a “MOON” symbol is displayed in the display area q2e.

In addition, combined symbol composed of the base symbol had been displayed and an “A” symbol is displayed in the display area q3e on the right side of the directing symbol in the display area q3d. Specifically, a combined symbol composed of an “UMBRELLA” symbol and an “A” symbol is displayed in the display area q3e. Subsequently, the arrows are erased and then only base symbols are displayed in the fifteen display areas q1a to q3e. And then, this processing is terminated.

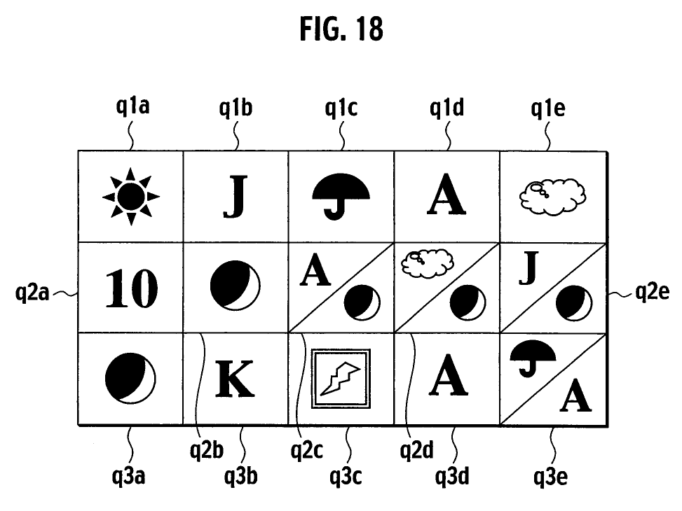

And then, in payout processing as shown in FIG. 9, two symbols contained in each combined symbol are considered as separated symbols to provide an award(s). For example, the combined symbol with a “Q” symbol and a “MOON” symbol displayed in the display area q2c shown in FIG. 18 is considered as two symbols of a “Q” symbol and a “MOON” symbol to provide an award(s). As a result, in the example shown in FIG. 18, since five “MOON” symbols and four “A” symbols are displayed, a forty-five medal award is provided as defined in the awards setting table shown in FIG. 6.

As explained above, in the slot machine 10 according to the third embodiment of the present invention, symbols are scrolled and then stopped in the fifteen display areas q1a to q3e. If a directing symbol(s) has appeared among the stopped symbols, symbols on the right side (positioned in the direction pointed by the arrow) of the directing symbol(s) are changed to a combined symbol composed of the base symbol had been displayed and the same base symbol as the base symbol contained in the directing symbol. Therefore, since expectations for more awards are provided to a player, an entertainment feature is advanced.

Note that, in the above embodiments, explained are the examples in which symbols are stopped sequentially from the left side in the display areas q1a to q3e and a directing symbol(s) containing a right-pointed arrow (directing sign) is displayed. However, the present invention is not limited to this. Symbols may be stopped sequentially from the right side in the display areas q1a to q3e and a directing symbol(s) containing a left-pointed arrow (directing sign) may be displayed.

Although embodiments of the present invention have been described as above, they are only presented as concrete examples, without particularly limiting the present invention. Concrete arrangements of respective units may be changed in design as appropriate. In addition, the effects set forth in the embodiments of the present invention are merely an enumeration of the most preferred effect which occurs from the present invention, and the effects by the present invention is not limited to those set forth in the embodiments of the present invention.

In the above detailed description, mainly characteristic portions have been set forth so that the present invention can be understood more easily. The present invention is not limited to the embodiments set forth in the above detailed description and can be applied to other embodiments, with a wide range of applications. In addition, terms and wordings used in the present specification are used to precisely explain the present invention and are not intended to limit the interpretation of the present invention. Also, those skilled in the art will easily conceive, from the concept of the invention set forth in the present specification, other arrangements, systems or methods included in the concept of the present invention. Therefore, it should be appreciated that the scope of the claims includes equivalent arrangements without deviating from the scope of technical ideas of the present invention. In addition, the purpose of the abstract is to facilitate the Patent Office and general public institutions, or engineers in the technological field who are not familiar with patent and legal terms or specific terms to quickly evaluate technical contents and the essence of this application by simple investigation. Therefore, the abstract is not intended to limit the scope of the invention, which should be evaluated by descriptions of the scope of the claims. Furthermore, it is desirable to take into consideration the already disclosed literatures sufficiently in order to completely understand the objects and specific effects of the present invention.

The above detailed description includes processes executed by a computer. The aforementioned descriptions and expressions are described with a purpose that those skilled in the art will understand them most efficiently. In the present specification, each step used for deriving one result should be understood as a self-consistent process. Also, transmission, reception and recording of electric or magnetic signals are executed in each step. In the processes in respective steps, although such signals are expressed as bits, values, symbols, characters, terms or numerals, it should be noted that these are merely used for convenience of explanation. Additionally, although the processes in respective steps may be described using an expression common to human activities, the processes described in the present specification are executed, in principle, by a variety of devices. Furthermore, other arrangements required to execute respective steps are self-evident from the aforementioned description.

What is claimed is:

1. A slot machine comprising:
a display including plural display areas, in each of which a base symbol or a directing symbol containing a base symbol and a directing sign is arranged; and
a controller operable to:
(A) rearrange one of the base symbol and the directing symbol in each of the display areas after receiving an input from an external,
(B) set, when the directing symbol has been rearranged in the display areas, the base symbol in each of the display areas positioned in a direction pointed by the directing sign contained in the rearranged directing symbol to the same base symbol as the base symbol contained in the rearranged directing symbol, and
(C) provide an award according to a symbol combination with the base symbols displayed in the display areas.

2. The slot machine according to claim 1, wherein
the controller is operable to rearrange the base symbol or the directing symbol in the display areas sequentially from the left side to the right side, and
the directing sign is an right-pointed arrow.

3. A slot machine comprising:
a display including plural display areas, in each of which a base symbol or a directing symbol containing a base symbol and a directing sign is arranged; and
a controller operable to:
(A) rearrange the base symbol or the directing symbol in each of the display areas after receiving an input from an external,
(B) change, after the base symbol or the directing symbol has been rearranged in each of the display areas, the base symbol in each of the display areas positioned in a direction pointed by the directing sign contained in the rearranged directing symbol to the same base symbol as the base symbol contained in the rearranged directing symbol, and
(C) provide an award according to a symbol combination with the base symbols displayed in the display areas.

4. The slot machine according to claim 3, wherein
the controller is operable to, in case where rearranging the directing symbol in the display areas and changing the base symbol in each of the display areas positioned in the direction pointed by the directing sign contained in the rearranged directing symbol, provide the award by combining an award according to the base symbols before changing and an award according to the base symbols after changing.

5. The slot machine according to claim 3, wherein
the controller is operable to rearrange the base symbol or the directing symbol in the display areas sequentially from the left side to the right side, and
the directing sign is an right-pointed arrow.

6. A slot machine comprising:
a display including plural display areas, in each of which a base symbol or a directing symbol containing a base symbol and a directing sign is arranged; and
a controller operable to:
(A) rearrange the base symbol or the directing symbol in each of the display areas after receiving an input from an external,
(B) change, after the base symbol or the directing symbol has been rearranged in each of the display areas, the base symbol in each of the display areas positioned in a direction pointed by the directing sign contained in the rearranged directing symbol to a combined symbol containing the base symbol had been arranged therein and the same base symbol as the base symbol contained in the rearranged directing symbol, and
(C) provide an award according to a symbol combination with the base symbols and the combined symbols displayed in the display areas.

7. The slot machine according to claim 6, wherein
the controller is operable to rearrange the base symbol or the directing symbol in the display areas sequentially from the left side to the right side, and
the directing sign is an right-pointed arrow.

8. A slot machine comprising:
a display including plural display areas, in each of which a base symbol or a directing symbol containing a base symbol, a directing sign and a numeric value is arranged; and
a controller operable to:
(A) rearrange the base symbol or the directing symbol in each of the display areas after receiving an input from an external,
(B) set, when the directing symbol has been rearranged in the display areas, the number, which is indicated the numeric value contained in the rearranged directing symbols, of the base symbols in the display areas positioned in a direction pointed by the directing sign contained in the rearranged directing symbol to the same base symbol as the base symbol contained in the rearranged directing symbol, and
(C) provide an award according to a symbol combination with the base symbols displayed in the display areas.

9. The slot machine according to claim 6, wherein
the controller is operable to rearrange the base symbol or the directing symbol in the display areas sequentially from the left side to the right side, and
the directing sign is an right-pointed arrow.

10. A control method of a slot machine, comprising:
rearranging symbol being arranged in each of plural display areas on a display to a base symbol or a directing symbol containing a base symbol and a directing sign,
changing, when the directing symbol has been rearranged in the display areas, the base symbol in each of the display areas positioned in a direction pointed by the directing sign contained in the rearranged directing symbol to the same base symbol as the base symbol contained in the rearranged directing symbol, and
providing an award according to a symbol combination with the base symbols displayed in the display areas.

11. The control method according to claim 10, wherein
the award, in case where rearranging the directing symbol in the display areas and changing the base symbol in each of the display areas positioned in the direction pointed by the directing sign contained in the rearranged directing symbol, is provided by combining an award according to the base symbols before changing and an award according to the base symbols after changing.

12. The control method according to claim 10, wherein
the base symbol or the directing symbol is rearranged in the display areas sequentially from the left side to the right side, and
the directing sign is an right-pointed arrow.
